(19) United States
(12) Patent Application Publication
(10) Pub. No.: US 2025/0030197 A1
(43) Pub. Date: Jan. 23, 2025

(54) ADAPTABLE PLUG-IN WALL TRANSFORMER

(71) Applicant: Digital Monitoring Products, Inc., Springfield, MO (US)

(72) Inventor: Rick A. Britton, Springfield, MO (US)

(73) Assignee: Digital Monitoring Products, Inc., Springfield, MO (US)

(21) Appl. No.: 18/775,940

(22) Filed: Jul. 17, 2024

Related U.S. Application Data
(60) Provisional application No. 63/514,831, filed on Jul. 21, 2023.

(51) Int. Cl. H01R 13/639; H01R 13/66

(52) U.S. Cl. CPC H01R 13/6395; H01R 13/6675

(57) ABSTRACT

An adaptable plug-in transformer includes a housing having a slot for receiving a securement tab, with the securement tab having an aperture therethrough for receiving a screw to allow attaching and securing the transformer to a wall outlet. The adaptable plug-in transformer thus may be used both in jurisdictions which require attachment or securement of plug-in transformers, and in jurisdictions which prohibit attachment or securement of plug-in transformers.

### CROSS-REFERENCE TO RELATED APPLICATIONS

This application claims the benefit of U.S. Provisional Patent Application No. 63/514,831, filed Jul. 21, 2023, the disclosure of which is hereby incorporated herein in its entirety by reference.

### BACKGROUND

Plug-in wall transformers for powering various commercial and consumer electronic equipment are ubiquitous. Virtually every home and business in the U.S. makes use of some version of such a plug-in transformer to power devices such as printers, alarm systems and equipment, telephones, gaming systems, phone charges, and various other equipment.

While plug-in wall transformers are well known and widely used, regulations regarding the use of such transformers vary widely. In some jurisdictions, laws and regulations require that protruding, plug-in transformers must be secured to the electrical outlet to prevent accidental dislodging of the transformer from the wall outlet. In other jurisdictions, laws and regulations prohibit the securement of plug-in transformers to the wall outlet and/or otherwise prohibit any impediment that would prevent a user from unplugging the transformer if necessary.

In view of the varying regulations, manufactures and sellers of equipment are essentially forced to offer two versions of otherwise identical plug-in transformers—one with an attachment/securement mechanism, and one without—in order to comply with the laws and regulations of the various jurisdictions in which they offer their products.

Thus it can be seen that there remains a need in the art for a plug-in transformer that avoids the problems imposed by the varying laws and regulations.

### SUMMARY

Embodiments of the invention are defined by the claims below, not this summary. A high-level overview of various aspects of the invention is provided here to introduce a selection of concepts that are further described in the detailed-description section below. This summary is not intended to identify key features or essential features of the claimed subject matter, nor is it intended to be used in isolation to determine the scope of the claimed subject matter. In brief, this disclosure describes an adaptable plug-in transformer that allows for configuration as a securable device—that is, the transformer is configured to be secured to a wall outlet—or as a non-securable device—that is, the transformer is configured such that it cannot be secured to the wall outlet.

In one embodiment, the housing of the adaptable plug-in transformer includes a slot formed therein for receiving a securement tab such that, when inserted into the slot, a portion of the securement tab protrudes from the housing. An aperture in the protruding portion of the securement tab has an aperture formed therethrough for receiving a screw to allow securing the transformer to the wall outlet. In a preferred embodiment the adaptable plug-in transformer is square or rectangular in shape with protruding electrical prongs configured to plug into an electrical wall outlet, with the aperture in the securement tab positioned to align with the an existing center screw hole of the wall outlet (i.e., the screw hole typically used to secure a face plate or cover to the outlet).

Thus, for use in jurisdictions requiring plug-in transformers to be secured to the wall outlet, the securement tab is inserted into the correspondingly shaped slot in the housing of transformer and a screw through the aperture in the tab secures the transformer to the wall outlet. For use in jurisdictions where securement of the transformer to the wall outlet is prohibited, the securement tab is not used, thus the plugged-in transformer has no means or mechanism to allow securement to the wall outlet.

In some embodiments the securement tab is sized to fit the slot in the transformer housing in line-to-line or frictional engagement so that the inserted tab is retained within the slot by frictional forces between the tab and the walls of the slot. In other embodiments, the securement tab includes a protruding boss or button that frictionally engages with a wall of the slot to retain the tab within the slot. In either case, the tab may be removed from the slot by pulling on the protruding portion of the tab.

### DESCRIPTION OF THE DRAWINGS

Illustrative embodiments of the invention are described in detail below with reference to the attached drawing figures, and wherein:

FIG. 1 is a perspective view of an adaptable plug-in transformer in accordance with an exemplary embodiment of the present invention.

FIG. 2 is a top view of the adaptable plug-in transformer of FIG. 1.

FIG. 3 is side view of the adaptable plug-in transformer of FIG. 1.

FIG. 4 is a back view of the adaptable plug-in transformer of FIG. 1.

FIG. 5 is a close-up, partial view of the adaptable plug-in transformer of FIG. 1, showing an insertable/removable tab and a slot in the transformer housing for receiving the tab.

FIG. 6A is an end view of the insertable/removable tab of FIG. 5.

FIG. 6B is a perspective view of the insertable/removable tab of FIG. 5.

### DETAILED DESCRIPTION

The subject matter of select embodiments of the invention is described with specificity herein to meet statutory requirements. But the description itself is not intended to necessarily limit the scope of claims. Rather, the claimed subject matter might be embodied in other ways to include different components, steps, or combinations thereof similar to the ones described in this document, in conjunction with other present or future technologies. Terms should not be interpreted as implying any particular order among or between various steps herein disclosed unless and except when the order of individual steps is explicitly described. The terms “about” or “approximately” as used herein denote deviations from the exact value in the form of changes or deviations that are insignificant to the function.

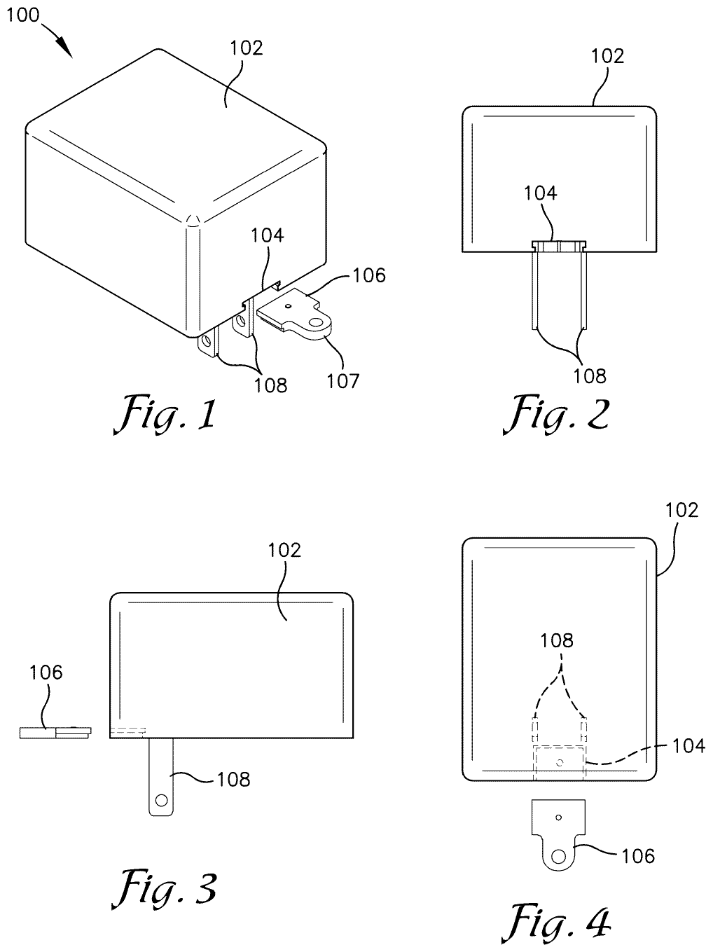

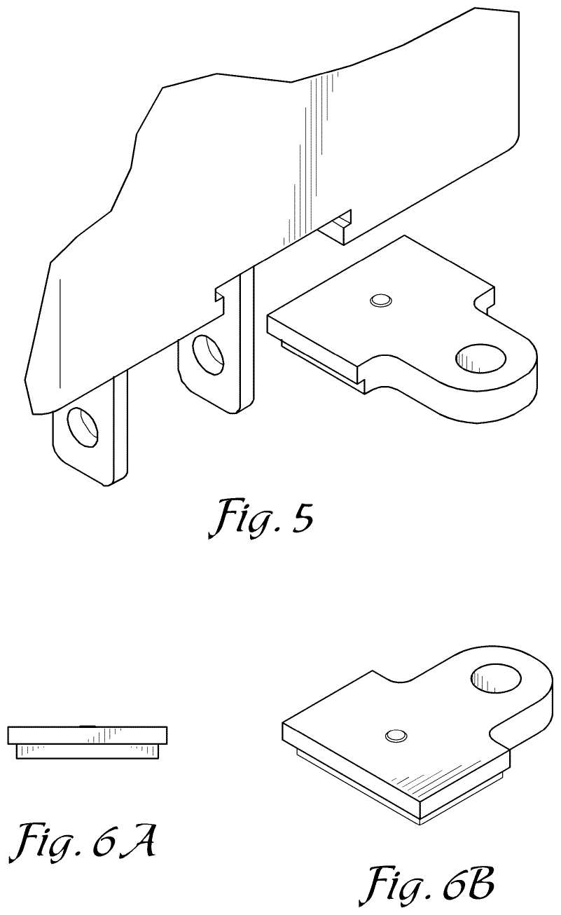

Looking first to FIGS. 1 through 4 in conjunction, an adaptable plug-in transformer in accordance with an exemplary embodiment of the present invention is depicted generally as 100. The transformer 100 includes a rectangular housing 102 in which electrical circuitry is contained, the circuitry operable to convert and/or condition line or mains voltage from a wall electrical outlet to a lower voltage alternating current (AC) or direct current (DC) that is used to power devices or equipment, such as alarm system equipment.

Two conductive prongs 108 extend from the back side of the housing 102, the prongs configured to plug into, or mate with, corresponding receptacles in an electrical wall outlet or socket. When plugged in to the wall outlet, the prongs conduct electricity to the electrical circuitry within the housing, and a lower voltage AC or DC output is provided to power devices or equipment.

As is known in the art, the size, shape, and number of prongs 108 extending from the housing may vary depending on the region or country in which the transformer is intended to be used. For example, in the United States, a wall transformer will typically include at least two prongs (i.e., one for the power/hot line and one for the neutral/return line) and may further include a third ground prong. In some cases, the prongs may be polarized or differently sized, with the neutral prong being wider than the hot prong so that the transformer may only be plugged into the wall outlet in a single orientation. In other countries or regions, the size and shape of the prongs may vary depending on the standards and regulations in place.

A stepped slot 104 is formed in the top back portion of the housing 102, i.e., the plug-in side of the transformer from which the prongs 108 extend. A securement tab 106 is configured and shaped to slidably fit into slot 104, with. As best seen in FIGS. 5, 6A, and 6B, the securement tab 106 comprises a generally rectangular main body portion 105 with a protruding semicircular rounded portion 107.

An aperture 109 is formed through the rounded portion 107 of the securement tab 106, the aperture configured to receive and allow the body of a securement screw to pass through.

With the securement tab 106 fitted into the slot 104 on the housing 102 and the wall transformer plugged into an electrical outlet, the aperture 109 algins with a center hole of the wall outlet so that the transformer 100 may be secured to the wall outlet via a screw passing through aperture. And, with the securement tab 106 omitted, the transformer has no aperture or other means of securing the transformer to the wall outlet.

Turning to FIGS. 5, 6A, and 6B, slot 104 is formed as a generally wide, “T” shaped slot, having a narrower portion 104b at the outermost portion of the back wall of the housing 102, and a wider portion 104a at the innermost portion of the slot 104 such that the transition from the narrower portion 104b to the wider portion 104a of the slot resembles a stair step.

Securement tab 106 is similarly shaped, with a wider portion 115 configured to slide into the wider portion 104a of the slot 104 and a narrower portion 113 configured to slide into the narrower portion 104b of the slot 104. Thus, an outer profile of the securement tab 106 and an inner profile of the slot 104 are similarly “T” shaped.

As can be seen in the figures, the securement tab 106 may be inserted into the similarly shaped slot 104 so that the rounded portion 107 of the securement tab protrudes from the housing 102 with the open aperture 109 available to receive a screw and secure the transformer to the wall outlet it is plugged in to. With the securement tab 106 removed from the slot (i.e., not being used), the transformer has no means to be secured to a wall outlet. Thus, the adaptable plug-in transformer of the present invention may be configured to conform with the requirements of jurisdictions that require securement of the transformer to the wall outlet and may also be configured to conform with the requirements of jurisdictions that prohibit securement of the transformer to the wall outlet.

In one embodiment, the size and dimensions of the securement tab 106 conforms to the size and dimensions of the slot in a line-to-line or friction fit configuration so that the securement tab 106 is frictionally secured within the slot when inserted, but can also be removed by a user if necessary using a pair of pliers or other tool.

As seen in FIG. 6B, in a preferred embodiment, a raised boss or button 111 protruded from the upper surface of the main body portion 105 of the securement tab 106. The button 111 provides a frictional engagement between the securement tab and the innermost wall of the slot 104 to frictionally secure the securement tab 106 within the slot. Thus, with the main body portion 105 of the securement tab 106 fully inserted into the slot 104, the tab 106 is secured within the slot 104, but can be removed by a user by gripping and pulling the protruding rounded portion 107 of the tab 106.

As can be seen, the adaptable plug-in transformer of the present invention provides for a single transformer being configurable to conform with regulations in various jurisdictions. Different arrangements of the various components depicted, as well as components not shown, are possible without departing from the scope of the claims below. For example, while the slot and tab configuration in the exemplary embodiments herein are depicted as a wide “T” shape, other shaped slots and tabs are contemplated by the present invention. And, while the exemplary embodiments herein depict usage with transformers configured for use in the U.S. (i.e., with two prongs), usage with other electrical connection configurations are within the scope of the present invention.

Identification of structures as being configured to perform a particular function in this disclosure and in the claims below is intended to be inclusive of structures and arrangements or designs thereof that are within the scope of this disclosure and readily identifiable by one of skill in the art and that can perform the particular function in a similar way. Certain features and sub-combinations are of utility and may be employed without reference to other features and sub-combinations and are contemplated within the scope of the claims.

What is claimed is:

1. An adaptable plug-in wall transformer, comprising:
a housing enclosing electrical circuitry for powering electronic equipment,
the housing comprising a slot for receiving a securement tab; and
a securement tab configured to slidably engage within the slot on the housing, wherein the securement tab includes an aperture therethrough for receiving a screw to attach and secure the transformer to a wall outlet.

2. The adaptable plug-in wall transformer of claim 1, wherein an inner profile of the slot and an outer profile of the securement tab are similar in shape.

3. The adaptable plug-in wall transformer of claim 2, wherein dimensions of the slot profile and dimensions of the securement tab profile are approximately equal such that the securement tab frictionally engages in the slot when inserted to retain the securement tab within the slot.

4. The adaptable plug-in wall transformer of claim 1, wherein the securement tab comprises a protruding button configured to frictionally engage with a wall of the slot when inserted to retain the securement tab within the slot.

5. The adaptable plug-in wall transformer of claim 1, wherein the securement tab comprises a main body portion configured to insert into the slot of the housing and a rounded portion configured to protrude from the housing when the securement tab is inserted into the slot.

6. The adaptable plug-in wall transformer of claim 5, wherein the aperture is positioned on the rounded portion of the securement tab.

7. The adaptable plug-in wall transformer of claim 5, wherein the main body portion of the securement tab comprises a narrower section adjacent a wider section, forming a “T” shape, and wherein the slot comprises a narrower section adjacent a wider section, forming a “T” shape.

8. An adaptable plug-in wall transformer, comprising:
a housing enclosing electrical circuitry for powering electronic equipment,
the housing comprising a “T” shaped slot for receiving a securement tab; and
a “T” shaped securement tab configured to slidably engage within the slot on the housing.

9. The adaptable plug-in wall transformer of claim 8, wherein dimensions of the slot profile and dimensions of the securement tab profile are approximately equal such that the securement tab frictionally engages in the slot when inserted to retain the securement tab within the slot.

10. The adaptable plug-in wall transformer of claim 8, wherein the securement tab comprises a main body portion configured to insert into the slot of the housing and a rounded portion configured to protrude from the housing when the securement tab is inserted into the slot.

11. The adaptable plug-in wall transformer of claim 10, wherein the main body portion of the securement tab comprises a protruding button configured to frictionally engage with a wall of the slot when inserted to retain the securement tab within the slot.

12. The adaptable plug-in wall transformer of claim 10, wherein the securement tab comprises an aperture therethrough for receiving a screw to attach and secure the transformer to a wall outlet.

13. The adaptable plug-in wall transformer of claim 12, wherein the aperture is positioned on the rounded portion of the securement tab.

14. An adaptable plug-in wall transformer, comprising:
a housing enclosing electrical circuitry for powering electronic equipment,
the housing comprising a “T” shaped slot for receiving a securement tab; and
a “T” shaped securement tab configured to slidably engage within the slot on the housing, the securement tab comprising an aperture formed therethrough for receiving a screw to attach the adaptable plug-in wall transformer to a wall outlet.

15. The adaptable plug-in wall transformer of claim 14, wherein the securement tab comprises a main body portion configured to insert into the slot of the housing and a rounded portion configured to protrude from the housing when the securement tab is inserted into the slot.

16. The adaptable plug-in wall transformer of claim 15, wherein the main body portion of the securement tab comprises a protruding button configured to frictionally engage with a wall of the slot when inserted to retain the securement tab within the slot.

17. The adaptable plug-in wall transformer of claim 15, wherein the aperture is formed through the rounded portion of the securement tab.
